(19) United States
(12) Patent Application Publication
(10) Pub. No.: US 2019/0177889 A1
(43) Pub. Date: Jun. 13, 2019

(54) METHOD OF WEAVING TUBULAR FABRIC, THE FABRIC, AND A BELT USING THE FABRIC

(71) Applicant: Gates Corporation, Denver, CO (US)

(72) Inventor: Min Gao, Wuxi (CN)

(21) Appl. No.: 15/841,175

(22) Filed: Dec. 13, 2017

(51) Int. Cl. D03D 13/00; D03D 3/02; D03D 15/06; F16G 5/20; F16G 5/22

(52) U.S. Cl. CPC D03D 13/008; D03D 3/02; F16G 5/22; F16G 5/20; D03D 15/06

(57) ABSTRACT

A method of making weaving a tubular fabric of particular usefulness in power transmission belting and other technical applications. The method includes weaving a secondary, removable warp yarn along with the primary warp yarn in the region of the edge folds on a shuttle loom. The removable warp yarn may be a soluble or meltable yarn. The removable yarn is removed after weaving, resulting in substantially uniform warp density all around the tubular fabric.

### BACKGROUND OF THE INVENTION

This invention relates generally to a method of weaving a tubular fabric, particularly to a method adjusting the yarn density in the fold region of tubular woven fabrics, specifically by incorporating a second yarn during weaving that can be removed after weaving, and power transmission belts which utilize the fabric as reinforcement or covering.

Tubular fabrics can be woven on a conventional shuttle loom. A conventional flat warp sheet can be woven into two layers joined continuously at the edges. The fold region which is produced at the edges of the fabric tube generally exhibits a higher density of warp yarns because the weft yarn insertion shuttle exerts a higher weave force in the tube edge area as the weft wraps around the edges. For many fabric uses or applications, this may not be a concern. However, if the fabric is intended for use in a technical application, such as a power transmission belt covering fabric, the non-uniformity in the area of the edges of the tube can result in belt irregularities that may be unsightly or detrimental to belt performance or drive-system performance. In particular, if the tube is used in the product as a tube, or if it is spiral cut to produce a continuous bias-oriented fabric for belt use, it may be impossible to avoid the non-uniform edge fold showing up somewhere in the belt.

Removable yarns have been used in knitting and weaving. U.S. Pat. No. 5,641,560 discloses a removable yarn used as a connecting yarn for separating a wide knit fabric into multiple narrower fabrics for making casts. The connecting yarn may be easily torn or removed by burning or dissolution. U.S. Pat. No. 5,732,749 discloses solvent removable binder yarns joining two plies of an integrally woven press fabric. After weaving the binder yarns are removed by dissolution yielding a laminated structure. U.S. Pat. No. 2,607,656 discloses a process of making fabric with a twistless cotton yarn that is supported by a highly polymerised polymethylene terephthalate yarn during the manufacture of the fabric. Then the fabric is treated with caustic soda solution to remove at least some of polymethylene terephthalate yarn leaving the twistless cotton.

JP2001-289283A discloses a toothed belt formed with a tooth cloth woven with 10-50% by mass of the warp threads being a water-soluble fiber, such as polyvinyl alcohol. The subsequent removal of the water-soluble fibers results in recesses and cavities on the belt toothed surface which reduce the generation of noise by the belt.

US 2013/0074795 A1 discloses a tubular woven fabric with fusible warp yarns along with other warp yarns which are unaffected at the temperature at which the fusible yarns melt, whereby the fabric can be adhesively attached to another fabric or other object.

### SUMMARY

The present invention is directed to systems and methods which provide tubular, shuttle-loom-woven fabric with good uniformity of weave in the fold area.

The inventive method involves flat, shuttle-loom weaving a tubular fabric using removable warp yarns along with the primary warp yarns in the folded edge region where the warp density is increased relative to the rest of the fabric. After weaving, the warp density in the fold or edge region is adjusted to substantially equal the density of the rest of the fabric by removing the removable warp yarns. The primary warp yarns may be aramid, polyamide, polyester, polyetheretherketone, cotton, or blends of fibers, or the like. Likewise, the weft yarns may be any desired yarn such as aramid, polyamide, polyester, polyetheretherketone, cotton, or blends of fibers, or the like.

In an embodiment, the removable yarns may be soluble yarns which are removable by dissolving in a suitable solvent that does not dissolve the primary warp yarns or the weft yarns. Preferably the removable yarns are water soluble. The removable yarns may be polyvinyl alcohol (PVA) yarns.

In another embodiment, the removable yarns may be meltable yarns which may be removable by heat at a temperature above the melt point but a temperature which does not melt or otherwise damage the primary warp yarns or the weft yarns. The meltable yarns may be, for example, polyolefin yarns or polyester yarns of suitable melting point, i.e., lower melting than the primary warp yarns or weft yarns.

The resulting adjusted tubular-woven fabric may be used in a technical application requiring substantially uniform warp yarn density. The resulting adjusted tubular-woven fabric may be used as a tooth covering fabric or a back-side fabric for synchronous belts, or as a band-ply fabric for wrapped V-belts, or as a back side fabric or rib covering fabric for multi-V-ribbed belts.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 illustrates variation of weave density in the fold area of a conventional tubular woven fabric;

FIG. 2 illustrates the variation of weave density in a tubular woven fabric with added spacer yarn in the fold area according to an embodiment of the invention;

FIG. 3 illustrates the variation of weave density in a tubular woven fabric after removal of the spacer yarn according to an embodiment of the invention;

FIG. 4 is a partially fragmented perspective view of a synchronous belt made according to an embodiment of the invention;

FIG. 5 is a sectional view of a V-ribbed belt made according to an embodiment of the invention; and

FIG. 6 is a perspective illustration of a woven fabric tube ready to apply to a cylindrical belt mold.

### DETAILED DESCRIPTION

The following definitions are used herein. Terms not otherwise defined have their usual meaning in the art. Warp refers to the set of yarns that run in the lengthwise direction of the woven fabric, which is also the direction of the axis of the woven tube. Weft refers to the yarn that runs circumferentially around the tube, which is also the direction approximately perpendicular the warp. Weft yarns are commonly called filling. Yarn is a generic term for any continuous strand of textile fibers, filaments, or material in a form suitable for weaving to form a textile fabric. Tube or tubing or tubular fabric refers to a fabric woven in cylindrical form with no lengthwise seams. Yarn density, including warp density or weft density, refers to the number of ends per unit width. Herein the units used are ends per 2.5 cm (approximately the same as ends per inch). Normal variation in warp density occurs in woven fabrics. The term “uniform” or “uniformity” with respect to yarn density allows for the presence of such density variations as are normally expected in the weaving arts, i.e., “uniform” means “substantially uniform.”

Flat weaving refers to the weaving on a shuttle loom with conventional flat warp or sheet of warp provided from a cylindrical warp beam. The lengthwise edges of the flat-woven tube are also referred to as the folds. Circular looms are not included, since they would not produce such edges or folds. Shuttleless looms are not generally used for tubular weaving.

The weave or weave style refers to the pattern of crossing between warp and weft. Any desired weave style may be used, including a plain or square weave, a twill, a satin, or a modified twill or modified satin.

FIG. 1 illustrates an edge portion (with the fold opened up and laid flat) of a conventionally prepared tubular woven fabric 10 with weft 12 and warp 14, showing the uniformly spaced warp yarns in the region 16 around an edge fold 18 where the warp yarn density is substantially increased.

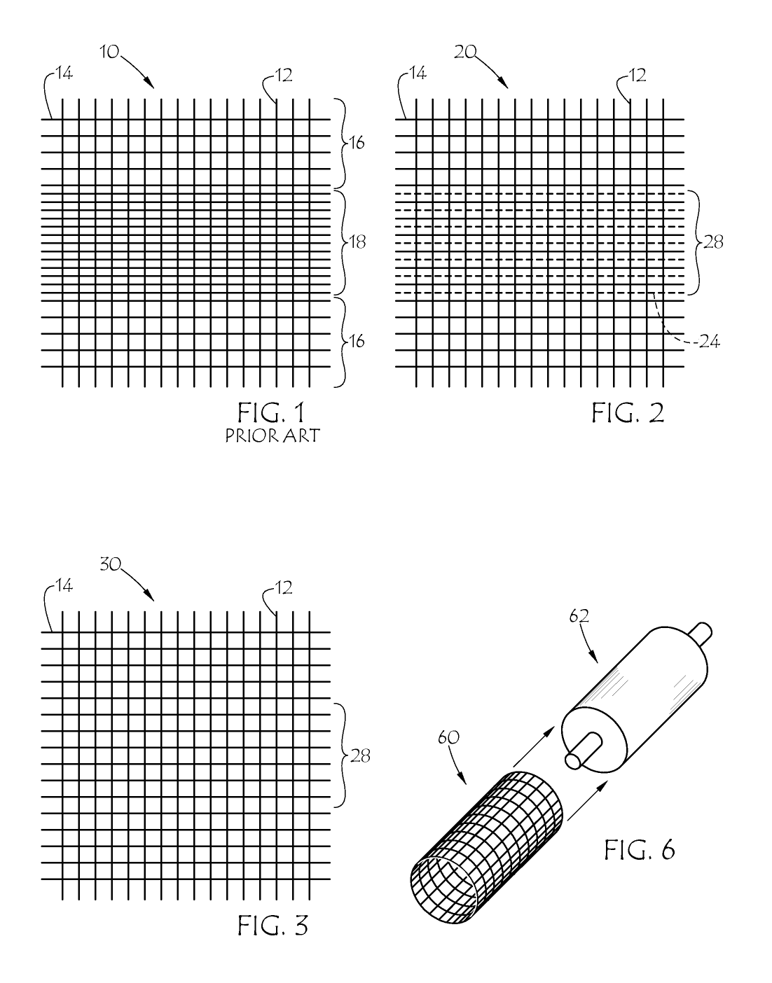

FIG. 2 illustrates an edge portion of a tubular woven fabric 20 prepared according to an embodiment of the invention, with weft 12 and primary warp 14 and additional removable warp 24 included in the region 28 of the higher density fold.

FIG. 3 illustrates a portion 30 of tubular woven fabric 20 after removal of the removable warp 24, showing the resulting uniform warp yarn density in the region 28 of the fold.

The inventive process may be practiced with any desired primary warp yarns and any desired weft yarns, provided the requirements for removing the removable, secondary warp yarns without disturbing the primary warp and the weft are met. Specifically useful yarn materials for primary warp and/or weft yarns include various performance materials like nylon, acrylic, polyester (PET), aramid, polyphenylenesulfide (PPS), polyetheretherketone (PEEK), polyethylenenaphthalate (PEN), polybenzobisoxazole (PBO), or cellulosics including natural fibers like cotton, or synthetics like rayon, or inorganic fibers such as glass, carbon fiber, boron, metal, etc. Various yarn constructions may be used as desired, including twisted, textured, wrapped, blends, etc.

Specific materials useful for the removable warp yarn, include water soluble fibers such as polyvinyl alcohol (PVA), alginate, and the like. Any solvent option can work as long as the primary warp yarn is not soluble and the removable fiber is soluble in that solvent or solvent system. PVA is a preferred removable fiber which can be removed by dissolving in hot water at about 90° C.

Low melting fibers such as polyethylene including (LDPE, HDPE, and the like), or polypropylene may be used for removing by melting. Preferably, the low melt fibers have a melting point less than 180° C., or more preferably in the range of 90° C. to 140° C. In one embodiment, steam heat is used to melt the low melt yarn, leaving the primary yarn on the fabric surface and providing uniform warp density in the fold region. The low melt material may be removed or it may be relocated by melt flow to one side of the fabric where it no longer affects the warp density.

After weaving and removal of the removable warp yarns, the fabric may be adjusted or post-treated, which may also serve to improve the uniformity of appearance in the fold region. Any desired adjustment or post-treatment process may be used, such as scouring, heat setting, adjusting the angle between warp and weft, treating, and the like. Other post-weaving processes may be applied, for example to prepare the fabric for a particular application, including: cutting or slitting; shifting the fabric angle; dipping, spraying or other treating methods with adhesives such as RFL, epoxy-latex, or rubber cement; laminating with plastic film; or coating one or both sides with rubber, upcoat cement, or other adhesives or by calendering.

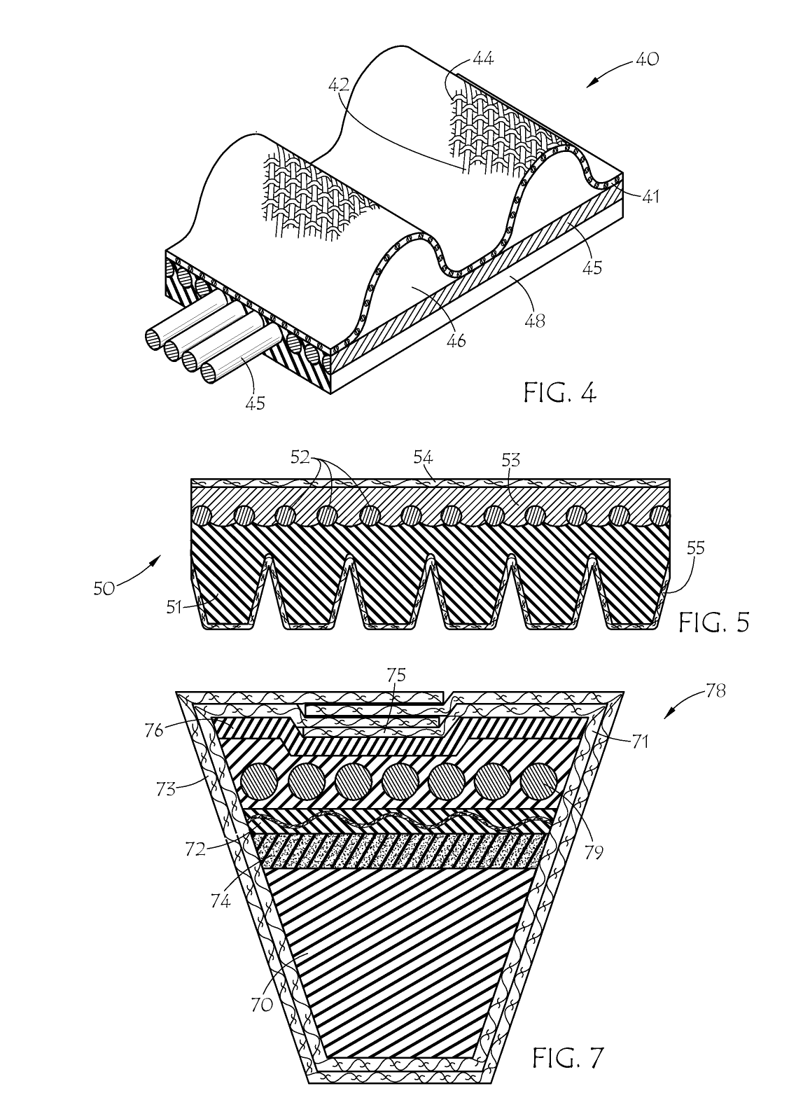

FIG. 4 shows a toothed belt with a fabric made according to an embodiment of the invention. In FIG. 4, toothed belt 40 has protruding transverse teeth 46 the surface of which are covered by fabric 41. Also shown are reinforcing tensile members 45 running in the longitudinal direction of the belt. Fabric 41 is shown as a bias-cut, woven fabric with warp 42 and weft 44. By bias-cut is meant the fabric is oriented on the bias, i.e., with the warp and weft both at approximately equal and opposite angles to the longitudinal direction of the belt. The angle may be approximately 45° (for example, as woven) or the angle may be shifted after weaving. The bias fabric may advantageously be balanced, i.e. with the same yarn construction used in both warp and weft. A preferred construction is a blend yarn combining desirable properties of two or more individual, distinct yarn materials, such as a yarn having a high temperature and heat resistance combined with a yarn having abrasion resistance or a yarn with high affinity for adhesion to belt body materials. Belt 40 may optionally have a back fabric on the side opposite the teeth, (not shown in FIG. 4) which may be made according to an embodiment of the invention. In some embodiments the balanced woven tooth cover fabric of blended yarn may be oriented with warp or weft parallel to the longitudinal direction of the belt. Also shown are reinforcing tensile members 45 running in the longitudinal direction of the belt. The rubber of the tooth 46 and that of the backside 48 of belt 40 may be the same or different, as may the rubber surrounding the tensile members 45. These rubber materials may be any suitable elastomeric or rubber composition(s) known in the art.

Instead of a balanced or symmetric woven fabric, which may be preferred for a bias-oriented belt cover fabric, the warp and weft yarns may be of different materials from each other. The warp may be oriented transverse to the belt longitudinal direction and the weft may be oriented parallel to the longitudinal direction, or vice versa. Thus, the warp and weft yarns may selected for the respective need depending on the orientation thereof in the belt. In a toothed belt, for example, the longitudinal direction may be of stretch yarns to facilitate tooth formation in the flow through process of belt making, or to facilitate longitudinal flexibility in any kind of belt. The transverse yarns may be less stretchy, or not stretchy for example, to facilitate belt transverse stiffness, as needed in V-belts. Both directions may be of a predetermined stretchiness, for example, to facilitate molding of multi-ribbed belts with such a rib covering fabric.

FIG. 5 is a sectional view of a V-ribbed belt, in a plane perpendicular to the belt longitudinal direction. V-ribbed belt 50 includes a rib-rubber layer 51 formed as a multi-ribbed structure, an adhesive rubber layer 53 in which tensile cords 52 are embedded, and a backing fabric 54 bonded to the back face of the adhesive rubber layer 53. In addition, the surface of the rib-rubber layer 51 is covered with a fabric 55. The tubular woven fabric of the invention may be used for the backing fabric 54 or for the rib fabric 55, as desired.

The fabric 55 is selected from material with sufficient stretchability to form around the ribs. Furthermore, the material is selected so as to afford sufficient durability to the belt in consideration of the performance required of the rib surface (e.g., in terms of wear resistance, heat resistance, stability of friction coefficient, water resistance, and slip and noise properties).

The belts may be manufactured according to any known method. For example a belt slab may be built up on a cylindrical mandrel or mold, including for example the various materials and layers shown in FIG. 4 or FIG. 5. The inventive tubular fabric may be applied to the mandrel as the first layer, or the last layer, or as any desired intermediate layer of the belt slab. The slab may cured or vulcanized on the mandrel, or it may be removed from a building mandrel and placed on a curing mold for vulcanization. The cured slab may be cut into individual belts and further processed if necessary. FIG. 6 is a perspective illustration of a woven fabric tube 60, made according to an embodiment of the invention, ready to apply to cylindrical belt mold 62.

FIG. 7 is a cross-section of a banded V-belt, showing two layers of band-ply fabric wrapped around the belt. Either or both band-ply layer may utilize the inventive fabric. The construction of V-belt 78 includes tensile members 79 embedded in a generally trapezoidal-shaped, belt body which is wrapped in two layers of band-ply (or cover) fabric, inner band 71 and outer band 73. The inventive belt may only have one layer of band-ply fabric, or it may have more than one layer. The belt body may be formed of rubber or rubber-like material, and may include various reinforcement layers, such as compression section rubber 70, tension section rubber layer 76, fiber-loaded rubber layer 74, and reinforcing fabric layer 72 which may be any type of reinforcing or supporting fabric such as woven, non-woven, tire cord, or the like, including an embodiment of the inventive fabric. Any desired number of rubber or reinforcement layers may be used in the belt body. The banded belt of the invention may be used for various applications including for automotive and industrial transmission of power between complimentary shaped sheaves or pulleys. Standard single strand industrial V-belt cross sections applicable for the belt of the invention include industry standard sizes A, B, C, and D, 2L, 3L and 4L and 3V, 5V, 8V and metric sizes SPZ, SPA, SPB and SPC. Any desired frictional belt cross section may utilize the fabric wrap according to the invention. For example, the V-shaped side surfaces may be somewhat concave, and/or the top and bottom surfaces may be crowned, or the belts may assume other conventional shape, such as round, or dual-V-shaped.

Applying the inventive tube process to make bias-shifted band-ply fabric for banded V-belts, it was discovered that a better, more consistent, yarn angle of around 110 degrees between warp and weft, measured across the belt width, was obtained than with a conventional shifted woven bias-fabric under the same belt application conditions.

The banded belts may be tied together side by side with a tie band for multiple belts to function as a single belt, for example in a multiple-V-belt drive. The tie band may be of the inventive.

In an example of the inventive method, polyester (PET) tubular woven fabric was made according to the inventive method and compared to the conventionally tubular woven fabric. Ex. 1 is the inventive fabric, woven with removable PVA warp yarns added amongst the PET yarns in the fold region during weaving and then removed with hot water after weaving. Comp. Ex. is the conventional fabric woven with only the same PET warp yarns. The same loom and same PET weft yarns were used for both fabrics. The same hot water wash was also used for both fabrics.

The results in TABLE 1 show the improvement in warp uniformity with the inventive method and fabric. For the Comparative Example, the thickness, warp density, tensile strength and weight per unit area are all significantly higher in the fold region that in the flat areas. However, for the inventive Ex. 1, the fold areas and flat areas are much more consistent, exhibiting substantially uniform warp density, tensile strength and weight per unit area.

TABLE 1

| | | Comp. |
|---|---|---|
| | Ex. 1 | Ex. |
| Thickness (mm) in flat area | 0.62 | 0.62 |
| Thickness (mm) in fold area | 0.64 | 0.69 |
| Warp density (end/cm) flat area | 15.2 | 15.2 |
| Warp density (end/cm) fold area | 15.6 | 18.4 |
| Tensile Strength (N/2.5 cm) flat area | 859 | 859 |
| Tensile Strength (N/2.5 cm) fold area | 859 | 1004 |
| Weight (g/cm²) flat area | 267 | 284 |
| Weight (g/cm²) fold area | 273 | 292 |

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

1. A method of making woven, continuous, bias fabric comprising:
selecting a weft yarn;
selecting a primary warp yarn and a removable secondary warp yarn;
flat weaving a fabric tube comprising two layers joined at two edge fold regions, with the secondary warp yarn present only in one or more of the two edge fold regions in an amount chosen to reduce the density of primary warp yarns in the fold region of the folds of the fabric to match the warp density in the rest of the fabric; and
removing the secondary warp yarn, and
spiral cutting the fabric.

2. The method of claim 1 wherein the secondary warp yarn is a water-soluble yarn.

3. The method of claim 2 wherein said removing comprises dissolving the water-soluble yarn with water.

4. The method of claim 3 wherein said water-soluble yarn comprises polyvinylalcohol fibers.

5. The method of claim 1 wherein the secondary warp yarn is a lower-melting yarn than the primary warp yarn and said removing comprises heating the fabric to melt the secondary warp yarn without melting the primary warp yarn.

6. The method of claim 1 further comprising adjusting the fabric after said removing.

7. The method of claim 1 wherein the resulting woven, bias fabric exhibits substantially uniform warp density.

8. A continuous, woven, bias fabric made by the method of claim 1.

9. A power transmission belt comprising the fabric of claim 8.

10. The power transmission belt of claim 9 in the form of a toothed belt comprising the woven fabric as a tooth covering fabric.

11. The power transmission belt of claim 9 in the form of a banded V-belt comprising the woven fabric as a band ply fabric.

12. The power transmission belt of claim 9 comprising the woven fabric as a backing fabric.
